(19) United States
(12) Patent Application Publication
(10) Pub. No.: US 2021/0109219 A1
(43) Pub. Date: Apr. 15, 2021

(54) METHOD AND DUAL FREQUENCY LIDAR SYSTEM FOR DETERMINING DISTANCE AND VELOCITY OF TARGET

(71) Applicant: INSTITUT NATIONAL DE LA RECHERCHE SCIENTIFIQUE (INRS), Quebec (CA)

(72) Inventors: Daniel ONORI, Longueuil (CA); Jose AZANA, Montreal (CA)

(73) Assignee: INSTITUT NATIONAL DE LA RECHERCHE SCIENTIFIQUE (INRS), Quebec (CA)

(21) Appl. No.: 16/597,263

(22) Filed: Oct. 9, 2019

(51) Int. Cl. G01S 17/58; G01S 7/48; G01S 7/4865

(52) U.S. Cl. CPC G01S 17/58; G01S 7/4866; G01S 7/4808

(57) ABSTRACT

There is provided a dual-frequency LIDAR system for determining a distance and velocity of a target and a method of operating the same. The system includes tunable lasers operable to generate a first signal, a second signal, and a third signal having a phase noise below the phase of the first signal. The system includes at least one coupler operable to: couple the first and second signal for directing a transmission signal on the target, couple a backscattered signal and the third signal to obtain a received signal, and couple the transmission signal and the third signal to obtain a reference signal. Digital processing techniques are used to determine the distance of the target by estimating a time delay between the transmission and reference signals via cross-correlation. The velocity is obtained by estimating a Doppler-frequency shift based on the time delay, the received signal and the transmission signal.

### FIELD

The present technology relates to Light Detection and Ranging (LIDAR) systems in general and more specifically to dual frequency LIDAR system for range and Doppler measurements and a method of operating the dual frequency LIDAR system.

### BACKGROUND

Target detection, identification, and tracking are fundamental operations in both commercial and military remote sensing applications. They must be carried out in a variety of harsh conditions that could include high target density, strong interferences, and jamming. To this aim, light detection and ranging (LIDAR) systems are widely used as alternative to, or in combination with, microwave radar sensors due to their intrinsic characteristics such as high optical-antenna gain, high directionality, and low sensitivity to jamming.

Depending on the application, LIDARs can exploit optical incoherent or coherent detection. Optically incoherent schemes, which resort to intensity detection, are only used for range extraction (e.g. time-of-flight rangefinders), while optically coherent architectures, which detect also the phase of the transmitted laser, are also able to obtain a direct measurement of the velocity (e.g. Doppler wind-LIDARs). Moreover, the coherent approach can reach higher distances with lower peak power, preserving a high range resolution, because it provides a coherence gain at hardware level due to the presence of a high-power local oscillator (LO) at the photodetector, increasing the system sensitivity.

Among the coherent LIDAR architectures, the most used ones are the pulse-Doppler and the modulated continuous wave (CW) LIDAR. A pulse-Doppler LIDAR determines the range to a target using pulse-timing techniques and uses the Doppler effect of the returned signal to determine the target object's velocity. However, it tends to be difficult to maintain and operate due to the high peak power level exploited, and the high-speed gating devices required to implement the pulse-timing technique. Instead, in modulated CW LIDARs, the transmitted light is amplitude/phase/frequency modulated in order to increase the bandwidth and consequently the range resolution, avoiding the transmission and detection of high peak power pulsed waveforms. Target detection and localization are accomplished by correlating the signal waveform reflected or backscattered from the target with a time-delayed reference.

A particular class of modulation waveforms includes random (or pseudo-random) waveforms; these are exploited by noise (or noise-like) LIDARs to avoid the use of any triggering hardware and to overcome any limitation concerning range and Doppler unambiguous detection occurring when repeated waveforms are used.

However, in noise LIDARs, as in other modulated CW LIDARs, any noise/distortion that affects the signal waveform reflected from the target, with respect to the reference waveform, causes a significant deterioration in the detection performance. The noise on the received signal arises due to various factors, e.g., speckle phase noise, induced by target's roughness and atmospheric turbulence (ambient noise), vibrations in the system setup and phase noise due to limited coherence length of the exploited lasers (system noise).

### SUMMARY

It is an object of the present technology to ameliorate at least some of the inconveniences present in the prior art. Embodiments of the present technology may provide and/or broaden the scope of approaches to and/or methods of achieving the aims and objects of the present technology.

Embodiments of the present technology have been developed based on developers' appreciation that there is a need for a LIDAR system that could be implemented by accessible components, that could be easy to integrate and that does not suffer from the drawbacks of the time-of-flights systems. Such a LIDAR system could be configured in an acoherent mode and allow to estimate a distance of a target, or could be configured in a coherent mode and allow to estimate both distance and velocity of the target.

Developers of the present technology have acknowledged that such a LIDAR system could use discrete components and be integrated on a chip. The LIDAR system could be integrated and used for remote sensing applications, such as remote sensing by autonomous vehicles for example.

Thus, embodiments of the present technology are directed to a method and dual frequency LIDAR system for determining distance and velocity of target

In accordance with a first broad aspect of the present technology, there is provided a method for determining a distance and a velocity of a target via a Light Detection and Ranging (LIDAR) system. The method comprises generating a first optical signal having a first phase noise, generating a second optical signal having a second phase noise, and generating a third optical signal having a third phase noise, the third phase noise being below the first phase noise and the second phase noise. The method comprises coupling the first optical signal and the second optical signal to obtain a transmission signal, and transmitting the transmission signal towards the target. The method comprises receiving a backscattered signal from the target, and coupling the backscattered signal and the third optical signal to obtain a received signal. The method comprises coupling the transmission signal and the third signal to obtain a reference signal, estimating a time delay between the received signal and the reference signal by cross-correlating the received signal and the reference signal. The method comprises determining, based on the time delay, the distance of the target, and determining a velocity of the target by estimating a Doppler-frequency shift based on: the time delay, the received signal and the reference signal.

In some embodiments of the method, a first optical frequency of the first optical signal is above a difference between a second optical frequency of the second optical signal and the first optical frequency.

In some embodiments of the method, the backscattered signal is the transmission signal having undergone at least one of: a time delay, a Doppler shift, and ambient phase noise.

In some embodiments of the method, the method further comprises, prior to the cross-correlating: applying a low-pass filter on the received signal and the reference signal to obtain a filtered received signal and a filtered reference signal and digitizing the filtered received signal and the filtered reference signal to obtain a digital received signal and a digital reference signal.

In some embodiments of the method, the method further comprises, prior to the applying the low-pass filter: generating at least one received electrical signal based on the received signal and at least one reference electrical signal based on the reference signal, and the low-pass filter is applied on the at least one received electrical signal and on the at least one reference electrical signal.

In some embodiments of the method, the estimating the time delay by cross-correlating the received signal and the reference signal comprises temporally sampling the digital received signal and the digital reference signal.

In some embodiments of the method, the estimating the time delay further comprises using a maximum of the cross-correlation function.

In some embodiments of the method, the estimating the time delay, the determining the distance of the target and the determining the velocity of the target are performed by a processing unit.

In some embodiments of the method, the generating the at least one received electrical signal is performed via a first set of photodiodes, and the generating the at least one reference electrical signal is performed via a second set of photodiodes.

In some embodiments of the method, the first optical signal is generated via a first tunable laser, wherein the second optical signal is generated via a second tunable laser, and wherein the third optical signal is generated via a third tunable laser.

In some embodiments of the method, the coupling is performed via at least one optical coupler.

In some embodiments of the method, the determining the velocity of the target comprises: delaying one of the received signal and the reference signal by the time-delay to obtain a time-delayed signal, and performing a time-domain product on the time-delayed signal and another one of the received signal and the reference signal to estimate the Doppler-frequency shift.

In accordance with a another broad aspect of the present technology, there is provided a light detection and ranging (LIDAR) system for determining a distance and a velocity of a target, the system comprising a first tunable laser operable to generate a first signal having a first phase noise, a second tunable laser operable to generate a second signal having a second phase noise, a third tunable laser operable to generate a third signal, the third signal having a third phase noise below the first phase and the second phase noise. The system comprises at least one coupler operable to: couple the first signal and the second signal to obtain a transmission signal for directing on the target, couple a backscattered signal from the target and the third signal to obtain a received signal, and couple the transmission signal and the third signal to obtain a reference optical signal. The system comprises a processing unit operable to: determine an estimated time delay between the received signal and the reference signal, determine a distance of the target based on the estimated time delay, and determine a velocity of the target by estimating a Doppler-frequency shift based on the time delay, the received signal and the reference signal.

In some embodiments of the system, the first tunable laser is a distributed feedback (DFB) laser, the second tunable laser is a first external cavity laser (ECL), and the third tunable laser is a third ECL.

In some embodiments of the system, the first tunable laser and the second tunable laser are operable to generate the first signal and the second signal such that a first optical frequency of the first signal is above a difference between a second frequency of the second optical signal and the first optical frequency.

In some embodiments of the system, the system further comprises at least one detector operable to: generate a received electrical signal based on the received signal and generate a reference electrical signal based on the reference signal.

In some embodiments of the system, the system further comprises at least one analog-to-digital converter (ADC) operable to: generate at least one received digital signal based on the received electrical signal and generate at least one reference digital signal based on the reference electrical signal.

In some embodiments of the system, the third tunable laser source is a narrow linewidth source.

In some embodiments of the system, the processing unit is operable to cross-correlate the at least one received digital signal and the at least one reference signal to determine the estimated time delay.

In some embodiments of the system, the processing unit is operable to temporally sample a combination of the at least one received digital signal and the at least one reference signal to determine the estimated time delay.

In some embodiments of the system, the system further comprises at least one low band-pass filter operable to filter the received electrical signal and the reference electrical signal to obtain a filtered received electrical signal and a filtered reference electrical signal for transmission to the at least one ADC.

In some embodiments of the system, the system further comprises at least one collimator to transmit the transmission signal and to receive the backscattered signal.

In some embodiments of the system, to determine the velocity of the target, the processing unit is operable to: delay one of the received signal and the reference signal by the time-delay to obtain a time-delayed signal; and perform a time-domain product on the time-delayed signal and another one of the received signal and the reference signal to estimate the Doppler-frequency shift.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of a dual frequency LIDAR system in accordance with non-limiting embodiments of the present technology.

FIG. 2 depicts a schematic diagram of signal inputs and outputs in the system of FIG. 1 in accordance with non-limiting embodiments of the present technology.

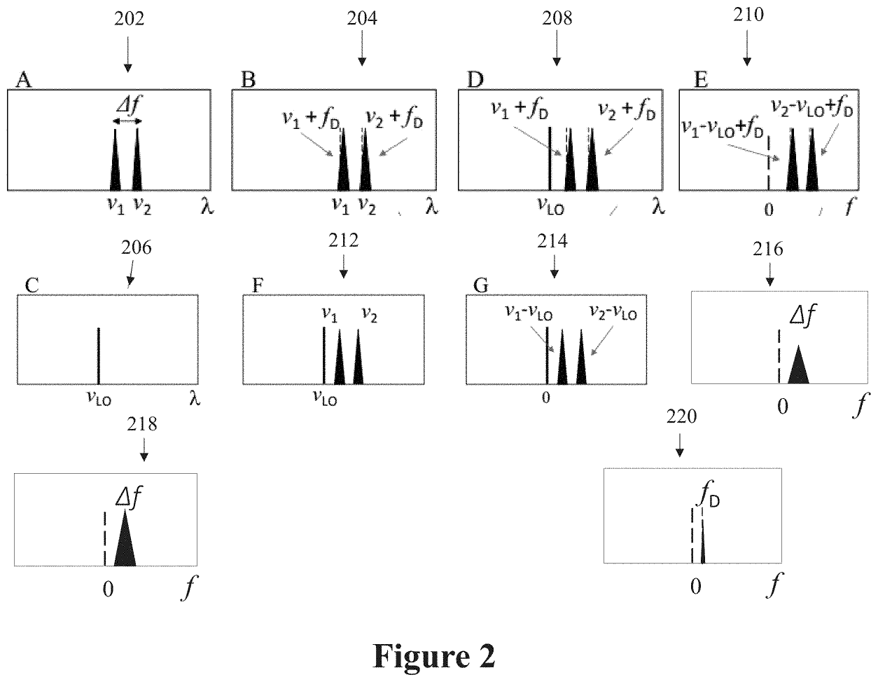

FIG. 3 depicts a schematic diagram of a single frequency LIDAR system in accordance with non-limiting embodiments of the present technology.

FIG. 4 depicts a schematic diagram of a practical implementation of the dual frequency LIDAR system of FIG. 1 in accordance with non-limiting embodiments of the present technology.

FIG. 5 depicts fast Fourier transformed (FFT) power spectrums of the signals obtained by the dual frequency LIDAR system of FIG. 4 in accordance with non-limiting embodiments of the present technology.

FIGS. 6A and 6B depict respectively range and velocity measurements obtained by the dual frequency LIDAR system of FIG. 4 in accordance with non-limiting embodiments of the present technology.

FIG. 7 depicts results of a single frequency implementation obtained by the dual frequency LIDAR of FIG. 4 in accordance with non-limiting embodiments of the present technology.

FIG. 8 depicts a flow chart of a method of determining a distance and a velocity of a target in accordance with non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

With these fundamentals in place, we will now consider some non-limiting examples to illustrate various implementations of aspects of the present technology.

### Dual Frequency LIDAR System

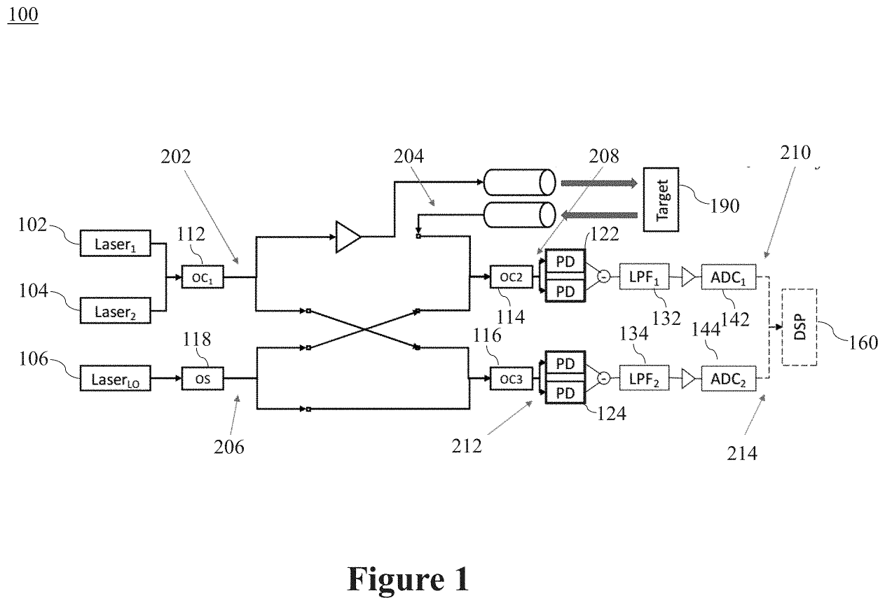

With reference to FIG. 1, there is shown a schematic diagram of a dual frequency LIDAR system 100, which will be referred to as the system 100, the system 100 being suitable for implementing non-limiting embodiments of the present technology. It is to be expressly understood that the system 100 as depicted is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The system 100 comprises inter alia a first laser source 102, a second laser source 104, a third laser source 106, a first optical coupler 112, a second optical coupler 114, an optical splitter 118, a first detector 122, a second detector 124, a first low-pass filter 132, a second low-pass filter 134, a first analog-to-digital converter (ADC) 142, a second analog-to-digital converter (ADC) 144, and a digital signal processing (DSP) unit 160.

The system 100 is said to be a dual-frequency LIDAR system, as it uses two distinct noise optical signals provided by the first laser source 102 and the second laser source 104. The system 100 is said to be a coherent LIDAR system because it is operable to detect a Doppler shift experienced by a backscattered signal from the target.

### Laser Sources

The first laser source 102 is a tunable laser source operable to generate a first signal, the first signal being a continuous wave signal. In some embodiments, the first laser source 102 is a distributed feedback (DFB) laser. As a non-limiting example, the first laser source has a 3 dB linewidth of 10 MHz.

The first laser source 102 generates a first signal having a first electrical field E₁ expressed as equation (1):

E₁(t)=A₁·e^{j(2π·v}^{₁}^{t+ϕ}^{₁}^{(t))} (1)

where A₁, is a first signal amplitude, v₁ is a first signal frequency, and ϕ₁(t) is a first signal phase noise.

The second laser source 104 is a tunable laser source operable to generate a second signal, the second signal being a continuous wave signal.

In some embodiments of the present technology, the second laser source 104 is an external cavity laser (ECL) in wide-linewidth mode. As a non-limiting example, the second laser source has a 3 dB linewidth of about 100 MHz.

The second laser source 104 generates a second signal having a second electrical field E₂ expressed as equation (2):

E₂(t)=A₂·e^{j(2π·v}^{₂}^{·t+ϕ}^{₂}^{(t))} (2)

Where A₂ is an amplitude of the second signal, v₂ is a frequency of the second signal, and ϕ₂(t) is a phase noise of the second signal.

The third laser source 106 is a tunable laser source operable to generate a third signal, the third signal being a narrow linewidth continuous signal. In some embodiments of the present technology, the third laser source 106 is an ECL. As a non-limiting example, the third laser source 106 has a 3 dB linewidth of 10 kHz.

The third laser source 106 generates a third signal 206 having an electrical field E_{LO} expressed as equation (3):

E_{LO}(t)=A_{LO}·e^{j(2π·v}^{_{LO}}^{·t+ϕ}^{_{LO}}^{(t))} (3)

Where A_{LO} is an amplitude of the third signal 206, v_{LO} is a frequency of the third signal 206, and ϕ_{LO}(t) is a phase noise of the third signal 206.

The phase noise of the third signal is below the phase of both the first signal and the second signal, i.e. ϕ₁, ϕ₂>>ϕ_{LO}.

### Optical Couplers and Optical Splitter

The first optical coupler 112 is operable to couple the first signal produced by the first laser source 102 and the second signal produced by the second laser source 104 to generate the optical transmission signal 202.

The first optical coupler 112 has two outputs which splits the optical transmission signal 202 into a transmission path (not numbered) and a reference path (not numbered). The transmission path enables transmitting the optical transmission signal 202 on the target 190, and the reference path enables generating a reference signal 212.

In some embodiments of the present technology, the first optical coupler 112 is a 3 dB fiber coupler.

The optical transmission signal 202 has a resulting electric field E(t) expressed as equation (4), with the 3 dB losses introduced by the first optical coupler 112 being neglected:

E(t)=E₁(t)+E₂(t)=A₁·e^{j(2π·v}^{₁}^{·t+ϕ}^{₁}^{(t))}+A₂·e^{j(2π·(v}^{₁}^{+Δf)·t+ϕ}^{₂}^{(t))} (4)

Where Δf=v₂−v₁ is a difference between the optical frequencies of the first signal and the second signal.

The optical splitter 118 is operable to split the third signal 206 into a transmission path third signal 206 and a reference path third signal 206.

In some embodiments of the present technology, the optical splitter 118 is a fiber splitter.

In the transmission path, the optical transmission signal 202 E(t) is amplified via an amplifier (not numbered) and collimated and transmitted through a telescope (not numbered) on the target 190, which reflects the optical transmission signal 202 back in the form of a backscattered signal 204.

A backscattered signal 204 is received by the system 100. In some embodiments of the present technology, the backscattered signal 204 may be received via a second collimator (not numbered).

The backscattered signal 204, having experienced a time delay, Doppler shift, and ambient phase noise, has an electric field E_{BS} which can be expressed as equations (5-7):

E_{BS}(t)=E₁_{_{BS}}(t)+E₂_{_{BS}}(t) (5)

E₁_{_{BS}}(t)=α·A₁·e^{j(2π·(v}^{₁}^{+f}^{_{D1}}^{)·(t-τ)+ϕ}^{₁}^{(t-τ)+ϕ}^{_{A}}^{(t))} (6)

E₂_{_{BS}}(t)=α·A₂·e^{j(2π·(v}^{₁}^{+Δf+f}^{_{D1}}^{)·(t-τ)+ϕ}^{₁}^{(t-τ)+ϕ}^{_{A}}^{(t))} (7)

where τ is the relative delay induced by a position of the target 190, a accounts for the optical amplification and free space losses, φ_{A}(t) is the experienced ambient phase noise, and f_{D} represent the Doppler shift, which depends on velocity of the target 190 as well as the carrier frequencies f_{D1} and f_{D2} expressed by equations (8) and (9), respectively:

$$\begin{matrix}{f}_{D 1} = \frac{2 ϵ {v}_{1}}{c} & ( 8 ) \\ {f}_{D 2} = \frac{2 ϵ {v}_{2}}{c} = \frac{2 ϵ ( {v}_{1} + Δ f )}{c} & ( 9 )\end{matrix}$$

where ε represents the target radial speed and c is the speed of light. It should be noted that since Δf<<v₁, f_{D1}≈f_{D2}=f_{D}

The second optical coupler 114 is operable to couple the backscattered signal 204 with the third signal 206 of the transmission path to obtain a received signal. The second optical coupler 114 is similar to the first optical coupler 112. The coupling of the backscattered signal 204 with the third signal 206 by the second optical coupler 2114 enables to measure a Doppler shift through optical hetereodyning.

In some embodiments of the present technology, the second optical coupler 114 is 3 dB fiber coupler.

The third optical coupler 116 is operable to couple the transmission signal 202 of the reference path and the third signal 206 of the reference path to obtain a reference signal 212.

In some embodiments of the present technology, the third optical coupler 116 is 3 dB fiber coupler.

### Detectors

The first detector 122 is operable to receive and heterodyne the received signal to generate a received electrical signal 208. The first detector 122 enables to perform a square-law operation on the received signal.

In some embodiments of the present technology, the first detector 122 comprises two photodiodes in a balanced configuration for heterodyning the received signal. In alternative embodiments of the present technology, a single photodiode could be used in the first detector 122 if intermediate signals at higher frequencies are generated and processed in the second Nyquist zone after filtering out the first Nyquist zone.

In some embodiments of the present technology, the first detector 122 enables performing a square-law operation on the reference signal.

The received electrical signal 208 at the output of the first detector 122 represented by i_{S} is a combination of the received electrical signal 208 at each photodiode i₁_{ₛ}, i₂_{ₛ} expressed by equations (10-12)

iₛ(t)=i₁_{ₛ}(t)+i₂_{ₛ}(t) (10)

i₁_{ₛ}(t)=κₛ·A_{LO}·A₁·e^{j(2π·(v}^{₁}^{-v}^{_{LO}}^{+f}^{_{D1}}^{)·(t-τ)+ϕ}^{₁}^{(t-τ)+ϕ}^{_{A}}^{(t))}) (11)

i₂_{ₛ}(t)=κₛ·A_{LO}·A₂·e^{j(2π·(v}^{₁}^{-v}^{_{LO}}^{+Δf+f}^{_{D1}}^{)·(t-τ)+ϕ}^{₁}^{(t-τ)+ϕ}^{_{A}}^{(t))} (12)

with κₛ being the amplitude term that accounts for the responsivity of the PDs in the first detector 122. It should be noted that i₁, i₂ may suffer a spectral corruption due to ambient noise and they could provide a noisy and inaccurate measure of the range of the target. It should be noted that iₛ(t) experiences a coherent gain by a factor of A_{LO}.

The second detector 124 is operable to receive and heterodyne the reference signal to generate a reference electrical signal 212. In some embodiments of the present technology, the second detector 124 comprises two photodiodes in a balanced configuration for heterodyning the reference signal. In alternative embodiments of the present technology, a single photodiode could be used in the second detector 124 if intermediate signals at higher frequencies are generated and processed in the second Nyquist zone after filtering out the first Nyquist zone.

The reference electrical signal 212 at the output of the second detector 124 represented i_{REF} is a combination of the output electrical signal at each photodiode i₁_{_{REF}} i₂_{_{REF}} expressed by equations (13-15)

i_{REF}(t)=i₁_{_{REF}}(t)+i₂_{_{REF}}(t) (13)

i₁_{_{REF}}(t)=κ_{REF}·A_{LO}·A₁·e^{j(2π·(v}^{₁}^{-v}^{_{LO}}^{)·t+ϕ}^{₁}^{(t-τ)+ϕ}^{_{A}}^{(t))} (14)

i₂_{_{REF}}(t)=κ_{REF}·A_{LO}·A₂e^{j(2π·(v}^{₁}^{-v}^{_{LO}}^{+Δf)·t+ϕ}^{₁}^{(t-τ)+ϕ}^{_{A}}^{(t))} (15)

where κ_{REF} is an amplitude term that accounts for the responsivity of the photodiodes in the second detector 124.

### Low-Pass Filter

The first low-pass filter 132 is operable to filter high frequencies of the received electrical signal 208 and transmit a filtered received electrical signal 210 to the first ADC 142.

The second low-pass filter 134 is operable to filter high frequencies of the reference electrical signal 212 and transmits a filtered detected signal 214 to the second ADC 144.

### Analog to Digital Converters (ADC)

The first ADC 142 is operable to digitize electrical signals by receiving the filtered received electrical signal 210 and generating a digital received signal 218.

The second ADC 144 is operable to digitize electrical signals by receiving the filtered electrical reference signal 214 and generating a digital reference signal 216.

It should be noted that among tones generated in the filtered received electrical signal, only three tones fold down within the bandwidth of the first low-pass filter 132, and two of these tones are generated by the coherent beating of E_{BS}(t) with E_{LO}(t) and their amplitudes are proportional to the amplitude of E_{LO}(t), thus performing a coherent amplification of the backscattered signal 204. The third term instead is the direct detection of the modes separated by Δf, which is very weak with respect to the coherent ones and is also further suppressed by means of the balanced detection and thus can be neglected.

It should be noted that the first low-pass filter 132, the second low-pass filter 134, the first ADC 142, and second ADC 144 may be implemented as a single device such as, but not limited to, real-time oscilloscope.

Digital Signal Processing (DSP) unit

The DSP unit 160 is operable to receive a squared digital received signal 218 from the first ADC 142 and a squared digital reference signal 216 from the second ADC 144 and to perform signal processing operations comprising inter alia cross-correlation and temporal sampling.

The DSP unit 160 enables extracting differential phase noise between the first laser source 102 and the second laser source 104, which is not affected by the ambient phase noise or the Doppler shift. The DSP unit 160 enables extracting differential phase noise of the squared digital reference signal 216.

In some embodiments of the present technology, the DSP unit 160 is operable to calculate fast Fourier transforms of digital signals. The DSP unit 160 is operable to perform 1D time-domain cross-correlations for distance detection, and time-domain products for velocity information.

In some embodiments of the present technology, the DSP unit 160 could be implemented using field-programmable gate array (FPGA) or application specific integrated circuits to achieve real-time or near real-time operation.

In some embodiments of the present technology, the DSP unit 160 may comprise inter alia a processor (not depicted), and a non-transitory computer-readable storage medium (not depicted) which can store computer-readable instructions.

Non-limiting examples of processors can include one or more general purpose microprocessors (for example, single or multi-core processors), application-specific integrated circuits, application-specific instruction-set processors, graphics processing units, physics processing units, digital signal processing units, coprocessors, network processing units, audio processing units, encryption processing units, and the like. Non-limiting examples of non-transitory computer-readable storage mediums include any type of disk including floppy disks, optical discs, DVD, CD-ROMs, Microdrive, and magneto-optical disks, ROMs, Rams, EPROMs, Proms, Drams, VRAMs, flash memory devices, magnetic or optical cards, Nano systems (including molecular memory ICs), or any type of media or device suitable for storing instructions and/or data.

The DSP unit 160 is operable to calculate a differential received noise P_{S} of the squared digital received signal 218 at the differential frequency Δ_{f}, which is expressed as equation (16):

P_{S}(t)=2·i₁_{ₛ}·i*₂_{ₛ}=2·κ_{S}²·A_{LO}²·A₁·A₂·e^{j(2π·Δf(t-τ)+ϕ}^{₁}^{(t-τ)+ϕ}^{₂}^{(t-τ))} (16)

The DSP unit 160 is operable to calculate a differential reference noise P_{REF} of the squared digital reference signal 216 at the differential frequency Δ_{f}, which is expressed as equation (17):

P_{REF}(t)=2·i₁_{_{REF}}·i*₂_{_{REF}}=2·κ_{REF}²·A_{LO}²·A₁·A₂·e^{j(2π·Δf·t+ϕ}^{₁}^{(t)+ϕ}^{₂}^{(t))} (17)

The DSP unit 160 is operable to perform a cross-correlation between the differential received noise P_{S} of the digital received signal 218 and the differential reference noise P_{REF} of the digital reference signal 216 expressed as XC_{P}_{_{S}}_{P}_{_{REF}}.

In some embodiments of the present technology, to perform the cross-correlation, the DSP unit 160 is operable to perform temporal sampling of the differential received noise P_{S} of the squared digital received signal 218 and the differential reference noise P_{REF} of the squared digital reference signal 216, which can be expressed as equation (18):

$${XC}_{{P}_{S} {P}_{REF}} ( {τ}^{′} ) = \{ \begin{matrix}{\sum }_{n = 0}^{N - {τ}^{′} - 1} {P}_{S} ( n + {τ}^{′} ) \cdot {P}_{REF} ( n ) , & {t}^{′} \geq 0 \\ {XC}_{{P}_{S} {P}_{R E F}} ( - {τ}^{′} ) , & {τ}^{′} < 0\end{matrix} \qquad ( 18 )$$

Where n, τ* are indices of the time-domain numerical samples and N is a total number of samples.

An estimate time delay τₑₛₜ of the time delay T may be calculated based on the cross-correlation XC_{P}_{_{S}}_{P}_{_{REF}}, the estimate time delay being expressed as equation (19):

$${τ}_{est} = {max}_{{τ}^{′}} \{ {XC}_{{P}_{S} {P}_{REF}} ( {τ}^{′} ) \} \qquad ( 19 )$$

A distance R of the target 190 can then be determined based on the estimated delay τₑₛₜ by equation (20):

$$R = \frac{c}{2} \cdot {τ}_{est} \qquad ( 20 )$$

Where c is the speed of light.

It should be noted that the distance of the target 190 is obtained without needing a priori information on the Doppler frequency shift f_{D}.

The DSP unit 160 is operable to perform time-domain products on the squared digital received signal 218 and the squared digital reference signal 216 based on the estimated delay τₑₛₜ to obtain a product signal 220 represented as P_{D} which is expressed as equations (21-22):

$$\begin{matrix}\begin{matrix}{P}_{D} ( t ) = 2 \cdot {i}_{{1}_{S}} \cdot {i}_{{1}_{REF}}^{*} ( t - {τ}_{est} ) \\ = {κ}_{est} \cdot {κ}_{REF} \cdot {A}_{LO}^{2} \cdot {A}_{1} \cdot {A}_{2} \cdot \\ {e}^{j ( 2 π \cdot {f}_{D} \cdot ( t - τ ) + {φ}_{0} + {φ}_{1} ( t - τ ) - {φ}_{1} ( t - {τ}_{est} ) + {φ}_{A} ( t ) )}\end{matrix} & ( 21 ) \\ {φ}_{0} = 2 π \cdot ( {v}_{1} - {v}_{LO} ) \cdot ( {τ}_{est} - τ ) & ( 22 )\end{matrix}$$

When τ=τₑₛₜ, equation (21) is expressed as equation (23):

$$\begin{matrix}{P}_{D} ( t ) = 2 \cdot {i}_{{1}_{S}} \cdot {i}_{{1}_{REF}}^{*} ( t - {τ}_{est} ) \\ = {κ}_{S} \cdot {κ}_{REF} \cdot {A}_{L O}^{2} \cdot {A}_{1}^{2} \cdot {e}^{j ( 2 π \cdot {f}_{D} \cdot ( t - τ ) + {φ}_{A} ( t ) )}\end{matrix} \qquad ( 23 )$$

The DSP unit 160 is operable to calculate a velocity of the target 190 by estimating the frequency Doppler frequency shift f_{D} based on equation (24):

$$ϵ = \frac{{f}_{D} \cdot c}{2 \cdot {v}_{1}} \qquad ( 24 )$$

In other words, the DSP unit 160 filters one of the noisy tones of the squared digital received signal 218 and the squared digital reference signal 216. The tone from the digital squared received signal 218 is time-delayed by an amount equal to τₑₛₜ. Then, the DSP unit 160 calculates time-domain product between these two tones to obtain a narrow-line tone product signal 220 at frequency f_{D}. By estimating f_{D}, the velocity of the target 190 can be obtained.

It should be noted that an estimate velocity of the target 190 via a Doppler shift measure suffers from the spectral broadening that is inherently induced by the ambient phase noise φ_{A}(t). However, the large center frequency of the optical sources exploited in the system 100 (ν₁ is about 193.4 THz) enhances considerably the frequency shift induced by the Doppler effect, which in turn translates into a higher velocity sensitivity.

Thus, the system 100 enables determining a distance or range of the target 190 by using two distinct noise optical signals provided by the first laser source 102 and the second laser source 104. The system 100 enables determining a velocity of the target 190 because it is operable to detect a Doppler shift experienced by a backscattered signal from the target 190.

It should be understood that at least a portion of the system 100 may be implemented on a chip.

Single Frequency LIDAR system

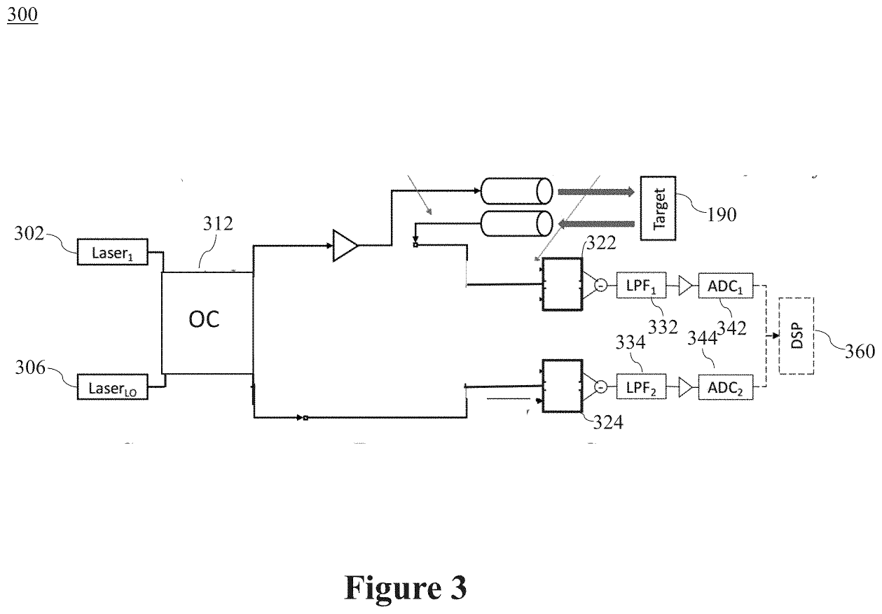

With reference to FIG. 3 there is depicted a schematic diagram of a single frequency LIDAR system 300 in accordance with non-limiting embodiments of the present technology.

The single frequency LIDAR system 300 can be obtained by using a portion of the components of the system 100. The single frequency LIDAR system 300 uses only one of the first laser source 102 and the second laser source 104 of the system 100, depicted as a laser source 302, thus becoming an acoherent LIDAR system to measure distance of the target 190.

The single frequency LIDAR system 300 comprises a reference laser source 306 equivalent to the third laser source 106, an optical coupler 312 equivalent to the first optical coupler 112, a first detector 322 equivalent to the first detector 122, a second detector 324 equivalent to the second detector 124, a first low-pass filter 332 equivalent to the first low-pass filter 132, a second low-pass filter 334 equivalent to the second low-pass filter 134, a first ADC 342 equivalent to the first ADC 142, a second ADC 344 equivalent to the second ADC 144, and a DSP unit 360 equivalent to the DSP unit 160.

The DSP unit 360 can calculate an estimated delay expressed as equation (25):

$${τ}_{est} = {max}_{{τ}^{′}} \{ {XC}_{{P}_{S} {P}_{REF}} ( {τ}^{′} ) \} \qquad ( 25 )$$

The received electrical signal at the output of the first detector 322 represented by iₛ can be expressed as equation (26):

i₁(t)=κₛ·A_{LO}·A₁·e^{j(2π·(v}^{₁}^{-v}^{_{LO}}^{+f}^{_{D1}}^{)·(t-τ)+ϕ}^{₁}^{)t-τ)+ϕ}^{_{A}}^{(t))} (26)

The reference electrical signal at the output of the second detector 324 can be expressed as equation (27):

i_{REF}(t)=κ_{REF}·A_{LO}·A₁·e^{j(2π·(v}^{₁}^{-v}^{_{LO}}^{)·t+ϕ}^{₁}^{(t))} (27)

The DSP unit 360 can obtain a distance R of the target 190 based on the estimated delay τₑₛₜ by equation (28):

$$R = \frac{c}{2} \cdot {τ}_{est} \qquad ( 28 )$$

### Experimental Results

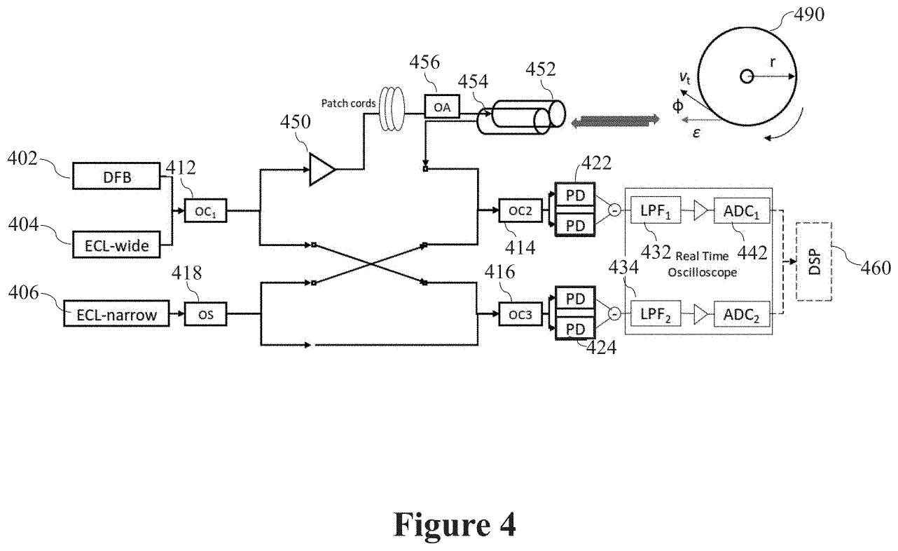

Now turning to FIG. 4, there is depicted schematic diagram of a practical implementation of the dual frequency LIDAR system of FIG. 1 in the form on system 400 accordance with non-limiting embodiments of the present technology.

The system 100 has been validated in a preliminary laboratory proof in the form of the system 400.

The system 400 comprises as a first tunable laser 402 as a distributed feedback laser of 3 dB linewidth of 10 MHz, a second tunable laser 402 as an ECL of 3 dB linewidth of 100 MHz, and a third tunable laser 406 as a second ECL of 3 dB linewidth of 10 kHz. The system 400 comprises the first optical coupler 412 in the form of a 3 dB fiber coupler, a second optical coupler 414 in the form of a 3 dB fiber coupler, a third optical coupler 416 in the form of a 3 dB fiber coupler, and an optical splitter 418 in the form of a fiber splitter.

The system 400 comprises a first detector 422 in the form of two photodiodes in a balanced configuration and a second detector 424 in the form of two photodiodes in a balanced configuration

The system 400 comprises an amplifier 450 in the form of an erbium doped fiber amplifier (EDDA) for boosting the transmitting optical signal E(t) up to 30 dB.

The system 400 comprises a first collimator 452 with an aperture of 3 mm for collimating the transmission signal after it has been boosted by the amplifier 450, and a second collimator 454 with an aperture of 3 mm for collimating the backscattered signal.

The system 400 comprises a real-time oscilloscope 430 comprising two-channel low-pass filters and two-channel ADC of Gap/s 10-bit.

The target 490 is a disk with a radius r of 4 cm, mounted in a DC motor the rotational speed of the motor can be changed acting on its DC supply voltage. The angle ϕ between the direction of the transmitted/reflected signal and the “direction of flight of the target”, i.e., the tangent to the perimeter of the disk, is around 20°.

The system 400 has been tested targeting the disk while rotating at around 10.000 rpm, i.e. with a tangential velocity vₜ of 41.9 m/s, and a radial velocity E of about 38.9 m/s. For this experiment, the integration time is set to 2 ms. The received power is set to −70 dBm through an optical attenuator (OA) 456.

A target range of around 29.7 m is emulated using fiber optic patch cords.

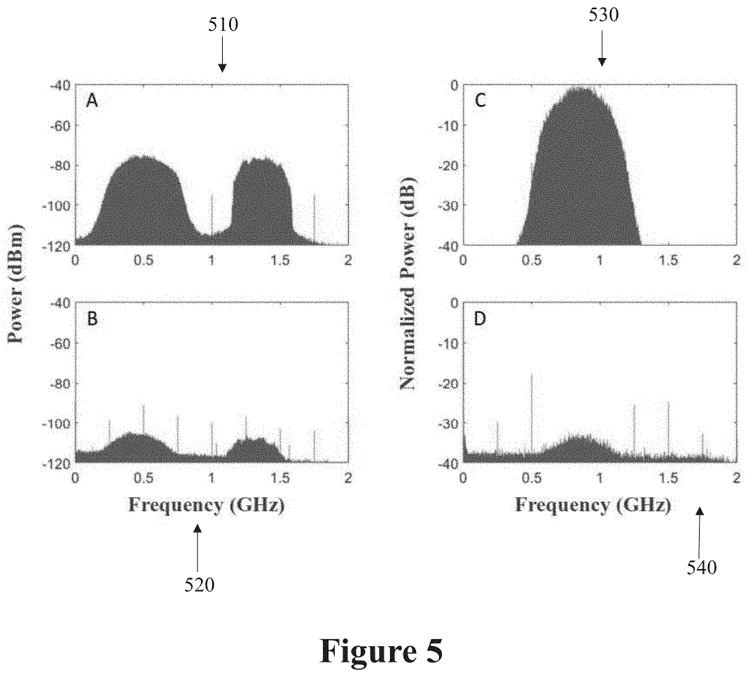

FIG. 5 depicts fast Fourier transformed (FFT) power spectrums of the signals in the system 400 in accordance with non-limiting embodiments of the present technology. A first FFT spectrum 510 represents the acquired reference signali_{REF}(t), a second FFT spectrum 520 represents the acquired received signal i_{S(t)}, a third FFT spectrum 530 represents the calculated differential-noise reference signal P_{REF} (t), and a fourth FFT spectrum 540 depicts a calculated differential-noise received signal and P_{S}(t).

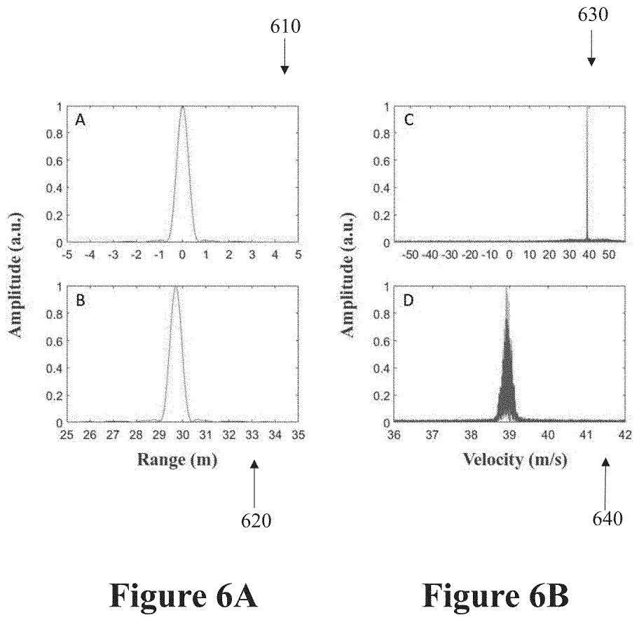

FIG. 6A depicts ranges measured by the system 400, with a range ambiguity function 610 showing a maximum range resolution (full width at half maximum—WHAM) of about 0.5 m, and a measured range profile 620 with a measure of the range of the target R=29.7 m (T_{EST}=0.149 μs). The estimated range is in agreement with the target one and no a priori information on the Doppler frequency shift is required to estimate the range.

FIG. 6B depicts velocities measurement obtained by Doppler frequency measurements with a measured velocity profile 630 obtained using the range estimation R to align the reference and received signal. The achieved Doppler shift f_{D} is 50.2 MHz, which corresponds to a radial velocity ε of about 38.91 m/s, again very close to the expected one. A zoomed measured velocity profile 640 shows a FWHM velocity resolution of around 0.15 m/s (corresponding to a frequency resolution of 200 kHz). Considering the theoretical maximum frequency resolution of the order of 500 Hz (set by the imposed acquisition time of 2 Ms), the resolution degradation is mainly attributed to the ambient noise, which is primarily caused by the vibrations introduced by the fast-rotating target in the reported experiment.

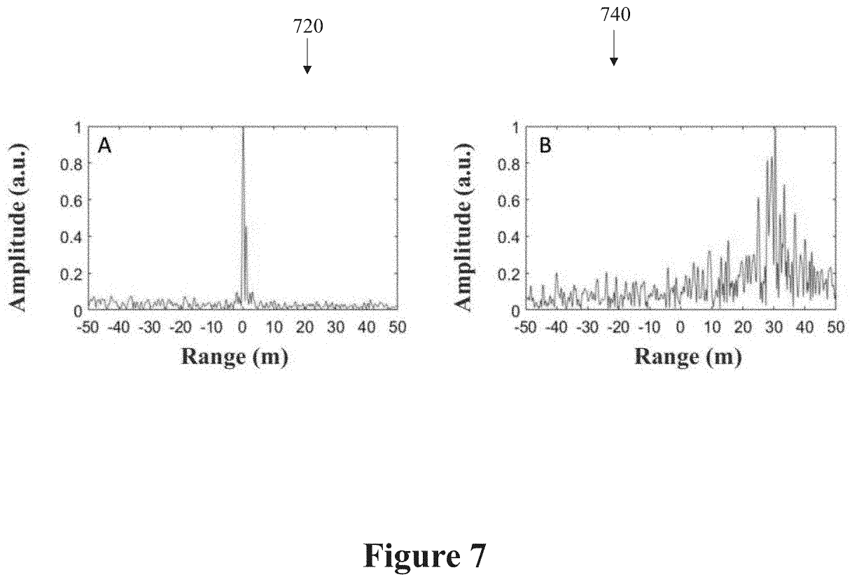

Finally, for comparison, the performance of the single frequency implementation has been evaluated as well, and results are depicted in FIG. 7. Now, the second tunable laser 404 has been turned off and the range estimation has been obtained where the range 720 shows the result of the cross-correlation XC between the reference signal i_{REF}(t) and the received signal i_{S}(t). Instead of the real range at 29.7 m, a false target at 0 m has been estimated. This wrong result is due to the frequency shift f_{D} experienced by i_{S}(t) with respect to i_{REF}(t). As a proof of concept, in order to cancel this Doppler frequency shift f_{D} that affects i_{S}(t) (obtained from the previous measurement through the system 400), the range estimation can be obtained based on equations (29-31):

$$\begin{matrix}{τ}_{est} = {max}_{{τ}^{′}} \{ {XC}_{{i}_{{S}_{shift}} {P}_{REF}} ( {τ}^{′} ) \} & ( 29 ) \\ {i}_{{s}_{shift}} ( t ) = {κ}_{s} \cdot {A}_{LO} \cdot {A}_{1} \cdot {e}^{j ( 2 π \cdot ( {v}_{1} - {v}_{LO} + {f}_{D 1} ) \cdot ( t - τ ) + {φ}_{1} ( t - τ ) + {φ}_{A} ( t ) )} & ( 30 ) \\ {i}_{REF} ( t ) = {κ}_{REF} \cdot {A}_{LO} \cdot {A}_{1} \cdot {e}^{j ( 2 π \cdot ( {v}_{1} - {v}_{LO} ) \cdot t + {φ}_{1} ( t ) )} & ( 31 ) \\ R = \frac{c}{2} \cdot {τ}_{est} & ( 32 )\end{matrix}$$

Neglecting the constant phase term e^{j(2π·f}^{_{D}}^{·τ))} i_{S}_{_{shift}}(t) and i_{REF}(t) differ only by the ambient phase noise term φ_{A}(t).

The result of the cross-correlation 740 shows that the range detection is corrupted by the noise φ_{A}(t).

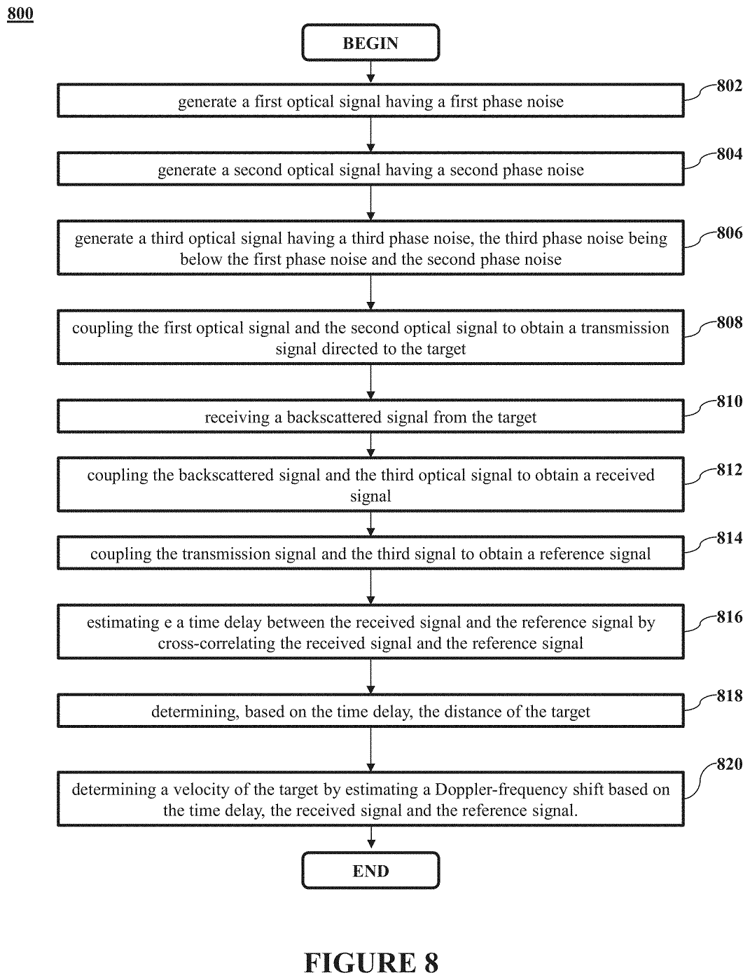

FIG. 8 depicts a flowchart of a method 800 of determining a distance and a velocity of a target in accordance with non-limiting embodiments of the present technology.

### Method Description

The method 800 may be executed within the system 100.

The method 800 begins at step 802.

STEP 802: Generating a First Optical Signal Having a First Phase Noise

At step 802, the first laser source 102 generates a first signal, the first signal being a continuous wave signal having a first phase noise and first frequency.

The method 800 advances to step 804.

STEP 804: Generating a Second Optical Signal Having a Second Phase Noise

At step 804, the second laser source 104 generates a second signal, the second signal being a continuous wave signal having a second phase noise a second frequency. The first optical frequency of the first optical signal is above a difference between a second optical frequency of the second optical signal and the first optical frequency.

The method 800 advances to step 804.

STEP 806: Generating a Third Optical Signal Having a Third Phase Noise, the Third Phase Noise being Below the First Phase Noise and the Second Phase Noise

At step 806, the third laser source 106 generates a third signal, the third signal being a narrow linewidth continuous signal having a third frequency and a third phase noise. The third phase noise of the third signal is below the first phase noise of the first signal and the second phase noise of the second signal

The method 800 advances to step 806.

STEP 808: Coupling the First Optical Signal and the Second Optical Signal to Obtain a Transmission Signal Directed on the Target

At step 808, the first optical coupler 112 couples the first signal produced by the first laser source 102 and the second signal produced by the second laser source 104 to generate the optical transmission signal 202 directed on the target 190. In some embodiments of the present technology, the optical transmission signal 202 is amplified and collimated. The system 100 transmits the optical transmission signal 202 towards the target 190.

The method 800 advances to step 810.

STEP 810: Receiving a Backscattered Signal

At step 810, the target 190 reflects the optical transmission signal 202 back in the form of a backscattered signal 204 which is received by the system 100. In some embodiments of the present technology, the backscattered signal 204 is received by a collimator. The backscattered signal 204 has experienced a time delay, Doppler shift, and ambient phase noise.

The method 800 advances to step 812.

STEP 812: Coupling the Backscattered Signal and the Third Signal to Obtain a Received Signal

At step 812, the second optical coupler 114 couples the backscattered signal 204 with the third signal 206 to obtain a received signal 208.

The method 800 advances to step 814.

STEP 814: Coupling the Coupled Transmission Signal with the Third Signal to Obtain a Coupled Reference Signal

At step 814, the third optical coupler 116 couples the transmission signal 202 of the reference path and the third signal 206 of the reference path to obtain a reference signal 212.

The method 800 advances to step 816.

STEP 816: Estimating a Time Delay Between the Digital Received Signal and the Digital Reference Signal Target by Cross-Correlating the Digital Received Signal and the Digital Reference Signal

At step 816, the first detector 122 receives and heterodynes the received signal 208 to generate a received electrical signal 208. The second detector 124 receives and heterodynes the reference signal to generate a reference electrical signal 212.

In some embodiments of the present technology, the first low-pass filter 132 filters frequencies of the received electrical signal 208 and transmits a filtered received electrical signal to the first ADC 142. The second low-pass filter 134 filters frequencies of the reference electrical signal 212 and transmits a filtered detected signal to the second ADC 144.

In some embodiments of the present technology, the first ADC 142 is operable to receive the filtered received electrical signal and to generate a digital received signal 218. The second ADC 144 is operable to receive the filtered electrical reference signal 214 and to generate a digital reference signal 216.

The DSP unit 160 is operable to receive the digital received signal 218 from the first ADC 142 and the digital reference signal 216 from the second ADC 144 and to perform signal processing operations comprising inter alia cross-correlation and temporal sampling.

The DSP unit 160 calculates a differential received noise P_{S} of the digital received signal 218 at the differential frequency Δ_{f}. The DSP unit 160 calculates to calculate a differential reference noise P_{REF} of the digital reference signal 216 at the differential frequency Δ_{f}, which is expressed as equation (17):

The DSP unit 160 performs temporal sampling of the differential received noise P_{S} of the digital received signal 218 and the differential reference noise P_{REF} of the digital reference signal 216. An estimate time delay τₑₛₜ of the time delay T may be calculated based on the cross-correlation XC_{P}_{_{S}}_{P}_{_{REF}}.

The method 800 advances to step 818.

STEP 818: Determining, Based on the Time Delay, the Distance of the Target

At step 818, the DSP unit 160 determines, based on the estimated time delay, the distance of the target 190 without knowledge of the Doppler-frequency shift.

The method 800 advances to step 820.

STEP 820: Determining a Velocity of the Target by Estimating a Doppler-Frequency Shift Based on: The Time Delay, the Received Signal and the Reference signal.

At step 820, the DSP unit 160 determines the velocity of the target 190 by estimating the frequency Doppler frequency shift f_{D}. The DSP unit 160 delays one of the signals by the time delay and performs a time-domain product of the signals to estimate the Doppler frequency shift f_{D}.

The method 800 ends.

In some embodiments of the present technology, steps 816-820 may be executed by a processor having received an indication of the first signal, the second signal, the third signal, the optical transmission signal 202, and the backscattered signal 204.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method for determining a distance and a velocity of a target via a Light Detection and Ranging (LIDAR) system, the method comprising:
generating a first optical signal having a first phase noise;
generating a second optical signal having a second phase noise;
generating a third optical signal having a third phase noise, the third phase noise being below the first phase noise and the second phase noise;
coupling the first optical signal and the second optical signal to obtain a transmission signal;
transmitting the transmission signal towards the target;
receiving a backscattered signal from the target;
coupling the backscattered signal and the third optical signal to obtain a received signal;
coupling the transmission signal and the third optical signal to obtain a reference signal;
estimating a time delay between the received signal and the reference signal by cross-correlating the received signal and the reference signal;
determining, based on the time delay, the distance of the target; and
determining a velocity of the target by estimating a Doppler-frequency shift based on: the time delay, the received signal and the reference signal.

2. The method of claim 1, wherein a first optical frequency of the first optical signal is above a difference between a second optical frequency of the second optical signal and the first optical frequency.

3. The method of claim 2, wherein the backscattered signal is the transmission signal having undergone at least one of: a time delay, a Doppler shift, and ambient phase noise.

4. The method of claim 3, wherein the method further comprises, prior to the cross-correlating:
applying a low-pass filter on the received signal and the reference signal to obtain a filtered received signal and a filtered reference signal; and
digitizing the filtered received signal and the filtered reference signal to obtain a digital received signal and a digital reference signal.

5. The method of claim 4, wherein
the method further comprises, prior to the applying the low-pass filter:
generating at least one received electrical signal based on the received signal and at least one reference electrical signal based on the reference signal; and wherein
the low-pass filter is applied on the at least one received electrical signal and on the at least one reference electrical signal.

6. The method of claim 5, wherein the estimating the time delay by cross-correlating the received signal and the reference signal comprises temporally sampling the digital received signal and the digital reference signal.

7. The method of claim 6, wherein the estimating the time delay further comprises using a maximum of the cross-correlation function.

8. The method of claim 7, wherein the estimating the time delay, the determining the distance of the target and the determining the velocity of the target are performed by a processing unit.

9. The method of claim 8, wherein the generating the at least one received electrical signal is performed via a first set of photodiodes, and the generating the at least one reference electrical signal is performed via a second set of photodiodes.

10. The method of claim 9, wherein
the first optical signal is generated via a first tunable laser; wherein
the second optical signal is generated via a second tunable laser; and wherein
the third optical signal is generated via a third tunable laser.

11. The method of claim 10, wherein the coupling is performed via at least one optical coupler.

12. The method of claim 1, wherein the determining the velocity of the target comprises:
delaying one of the received signal and the reference signal by the time delay to obtain a time-delayed signal; and
performing a time-domain product on the time-delayed signal and an other one of the received signal and the reference signal to estimate the Doppler-frequency shift.

13. A light detection and ranging (LIDAR) system for determining a distance and a velocity of a target, the system comprising
a first tunable laser operable to generate a first signal having a first phase noise;
a second tunable laser operable to generate a second signal having a second phase noise;
a third tunable laser operable to generate a third signal, the third signal having a third phase noise below the first phase and the second phase noise;
at least one coupler operable to:
couple the first signal and the second signal to obtain a transmission signal for directing on the target;
couple a backscattered signal from the target and the third signal to obtain a received signal; and
couple the transmission signal and the third signal to obtain a reference optical signal;
a processing unit operable to:
determine an estimated time delay between the received signal and the reference signal;
determine a distance of the target based on the estimated time delay; and
determine a velocity of the target by estimating a Doppler-frequency shift based on the time delay, the received signal and the reference signal.

14. The system of claim 13, wherein the first tunable laser and the second tunable laser are operable to generate the first signal and the second signal such that a first frequency of the first signal is above a difference between a second frequency of the second signal and the first frequency.

15. The system of claim 14, further comprising:
at least one detector operable to:
generate a received electrical signal based on the received signal; and
generate a reference electrical signal based on the reference signal
at least one analog-to-digital converter (ADC) operable to:
generate at least one received digital signal based on the received electrical signal; and
generate at least one reference digital signal based on the reference electrical signal.

16. The system of claim 15, wherein the third tunable laser source is a narrow linewidth source.

17. The system of claim 16, wherein the processing unit is operable to cross-correlate the at least one received digital signal and the at least one reference digital signal to determine the estimated time delay.

18. The system of claim 17, wherein to determine the velocity of the target, the processing unit is operable to:
delay one of the received signal and the reference signal by the time delay to obtain a time-delayed signal; and
perform a time-domain product on the time-delayed signal and an other one of the received signal and the reference signal to estimate the Doppler-frequency shift.

19. The system of claim 18, further comprising at least one low band-pass filter operable to filter the received electrical signal and the reference electrical signal to obtain a filtered received electrical signal and a filtered reference electrical signal for transmission to the at least one ADC.

20. The system of claim 19, further comprising at least one collimator to transmit the transmission signal and to receive the backscattered signal.
